(19) United States
(12) Patent Application Publication
(10) Pub. No.: US 2024/0416711 A1
(43) Pub. Date: Dec. 19, 2024

(54) Damping arrangement for an axle of a motor vehicle

(71) Applicant: Dr. Ing. h. c. F. Porsche Aktiengesellschaft, Stuttgart (DE)

(72) Inventors: Tobias Lörcher, Filderstadt (DE); Stefan Hartlieb, Filderstadt-Plattenhardt (DE)

(73) Assignee: Dr. Ing. h. c. F. Porsche AKtiengesellschaft, Stuttgart (DE)

(21) Appl. No.: 18/636,391

(22) Filed: Apr. 16, 2024

(30) Foreign Application Priority Data
Jun. 13, 2023 (DE) 102023115402.8

(51) Int. Cl. B60G 21/073; B60G 17/015

(52) U.S. Cl. CPC B60G 21/073; B60G 17/0152; B60G 2202/413; B60G 2204/82

(57) ABSTRACT

A damping arrangement of an active chassis for an axle of a motor vehicle, wherein a damping system cooperates with each wheel of the axle. Each of the damping systems includes a damper having a double-acting hydraulic cylinder and a piston. The damper is couplable to a wheel suspension system of the respective wheel. A hydraulic pump and an electric motor drives the respective hydraulic pump, wherein the hydraulic pump is driven by the electric motor in different directions of rotation to provide different conveying directions. A hydraulic unit includes a hydraulic reservoir and valves, wherein the hydraulic pump and the hydraulic unit of the respective damping system cooperate with hydraulic chambers of the hydraulic cylinder of the respective damping system, such that, depending on the conveying direction of the hydraulic pump, a movement of the piston in either a first or second actuation direction can be provided.

### CROSS-REFERENCE TO RELATED APPLICATION

This application claims priority to German Patent Application No. 10 2023 115 402.8, filed Jun. 13, 2023, the content of such application being incorporated by reference herein in its entirety.

### FIELD OF THE INVENTION

The invention relates to a damping arrangement of an active chassis of a motor vehicle for an axle of the motor vehicle, and to a motor vehicle.

### BACKGROUND OF THE INVENTION

DE 10 2017 117 658 B4 and DE 10 2019 115 492 B4, which are each incorporated by reference herein, each disclose a damping system for a wheel of a motor vehicle, having a damper, a hydraulic pump driven by an electric motor, a hydraulic reservoir, and multiple valves. The damper is formed from a double-acting hydraulic cylinder and a piston movable in a reciprocating manner within said cylinder. The hydraulic pump is coupled to hydraulic chambers of the hydraulic piston via hydraulic lines, wherein a movement of the piston in a first actuation direction or in a second actuation direction can be provided depending on the conveying direction of the hydraulic pump.

An axle of a motor vehicle comprises two wheels that engage with a subframe or auxiliary frame via respective wheel suspensions. A subframe engages decoupled on a body of the motor vehicle via bearings. An auxiliary frame is not decoupled from a body of the motor vehicle.

An axle of an active chassis is provided with a damping system for each wheel. The two damping systems for the two wheels of an axle are part of a damping arrangement of the respective axle of the motor vehicle.

It is known from DE 10 2019 118 384 A1, which is incorporated by reference herein, that the electric motor and the hydraulic pump of a damping system of a respective wheel of an axle of an active chassis are combined to form a motor-pump group. A common electronic unit cooperates with both motor-pump groups of a respective axle to drive the electric motors. The electronic unit is installed between the two motor-pump groups. The two motor-pump groups form a motor-pump unit, which is installed via receptacles on the motor vehicle, preferably in proximity to the respective axle. The common electronic unit is part of the motor-pump unit of the damping arrangement.

DE 10 2018 122 226 A1, which is incorporated by reference herein, discloses an auxiliary frame on the subframe of a motor vehicle for receiving a motor-pump group of a damping system of an active chassis.

### SUMMARY OF THE INVENTION

In practice, it has been shown that the motor-pump unit of a damping arrangement of an axle of an active chassis vibrates strongly while the motor vehicle travels, in particular due to excitation from the roadway. This may be disadvantageous. There may therefore be a need for a damping arrangement of an axle of an active chassis of a motor vehicle in which the motor-pump unit of the damping arrangement vibrates less strongly.

Described herein is a damping arrangement of an axle of an active chassis of a motor vehicle, in which the motor-pump unit vibrates less without affecting noise development, and thus without impairing the acoustics when the motor vehicle travels. It is further intended to provide a motor vehicle having such a damping arrangement.

In the damping arrangement according to aspects of the invention, the motor-pump unit is attached to a subframe or to an auxiliary frame of the axle of the active chassis via a carrier, preferably to connection areas of the subframe or auxiliary frame for a stabilizer.

In the damping arrangement according to aspects of the invention, the motor-pump unit is attached to the subframe or the auxiliary frame of the axle of an active chassis via a carrier, preferably to connection areas of the subframe or auxiliary frame for a stabilizer. This is preferred to ensure that the motor-pump unit of the damping arrangement of the axle of the active chassis vibrates less strongly when the motor vehicle travels, without affecting noise development, and thus without impairing the acoustics.

It is possible to shift natural frequencies of the motor-pump unit as far as possible out of the range of existing excitation frequencies, e.g., by wheel excitation, and without impairing the acoustics.

Preferably, instead of a stabilizer, the carrier is attached to the connection areas of the subframe or to the connection areas of the auxiliary frame for a stabilizer, wherein the carrier extends in the design space for the stabilizer instead of a stabilizer. This is particularly preferred to further reduce the tendency of the motor-pump unit of the damping arrangement of the axle of the active chassis to vibrate, without impairing the acoustics.

According to a first variant of the invention, the motor-pump unit of the damping arrangement of the axle of the active chassis is arranged below the carrier, wherein the carrier is rigidly attached to the subframe or auxiliary frame, and wherein either the motor-pump unit is rigidly attached to the carrier or the motor-pump unit is attached to the carrier via bearings, which have a bearing stiffness of between 450 N/mm and 850 N/mm, preferably between 500 N/mm and 800 N/mm, particularly preferred between 550 N/mm and 750 N/mm or between 600 N/mm and 700 N/mm, in the radial direction of the bearing, and thus in the longitudinal direction and vertical direction of the motor vehicle.

According to a second variant of the invention, the motor-pump unit of the damping arrangement of the axle of the active chassis is integrated into the carrier, such that the motor-pump unit divides the carrier into two portions, and that one of the portions of the carrier extends on each side of the motor-pump unit, wherein either the carrier is rigidly attached to the subframe or auxiliary frame or the carrier is attached to the subframe or auxiliary frame via bearings, which have a bearing stiffness between 450 N/mm and 850 N/mm, preferably between 500 N/mm and 800 N/mm, particularly preferred between 550 N/mm and 750 N/mm or between 600 N/mm and 700 N/mm, in the longitudinal direction and the vertical direction of the motor vehicle.

Both the first variant and the second variant of the invention may reduce the tendency of the motor-pump unit of the damping arrangement of the axle of the active chassis to vibrate when the motor vehicle travels. The variant selected depends in particular on a design space available in the area of the subframe or auxiliary frame.

### BRIEF DESCRIPTION OF THE DRAWINGS

Preferred further developments of the invention follow from the subclaims and the following description. Without being restricted thereto, example embodiments of the invention are explained in greater detail with reference to the drawings. In the drawings:

FIG. 1 shows a schematic representation of hydraulic assemblies of a damping arrangement according to aspects of the invention for the wheels of an axle of an active chassis according to aspects of the invention;

FIG. 2 is a cut-out of a motor vehicle according to aspects of the invention in the area of a subframe and a motor-pump unit of the damping arrangement according to aspects of the invention;

FIG. 3 is a detail of FIG. 2;

FIG. 4 is an alternative to the detail of FIG. 2;

FIG. 5 is a diagram to illustrate the effect or influence of the damping arrangement according to aspects of the invention on the vibration of the motor-pump unit of the damping arrangement.

### DETAILED DESCRIPTION OF THE INVENTION

A motor vehicle, such as a passenger vehicle, has multiple axles. Each axle has two wheels, which typically engage with a subframe of the respective axle via corresponding wheel suspensions. The subframe of the respective axle engages decoupled on a body of the motor vehicle via bearings. The wheel suspensions may also engage on an auxiliary frame that does not engage decoupled on the body of the motor vehicle. Subframes shells can preferably be used in the area of a rear axle and auxiliary frame, preferably in the area of a front axle. In the following, the invention is described in the event that the wheel suspensions engage on a subframe.

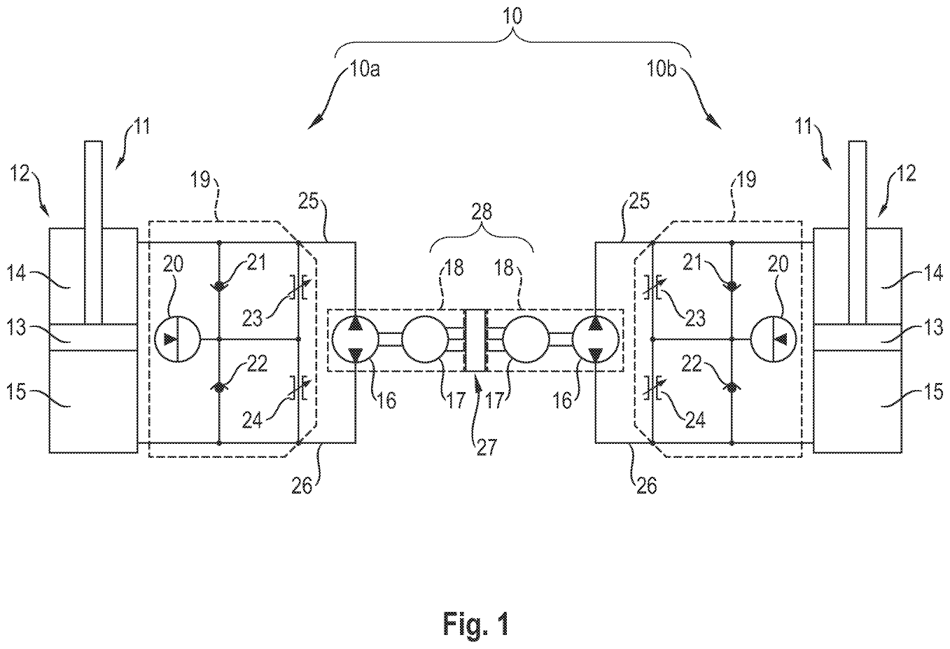

If the respective axle of the motor vehicle is the axle of an active chassis of the motor vehicle, a damping arrangement 10 is present for the two wheels of the axle of the active chassis, wherein FIG. 1 shows a preferred embodiment of a damping arrangement 10 for the two wheels of an axle of an active chassis of a motor vehicle.

The damping arrangement 10 of an axle of the active chassis has a damping system 10a, 10b for each wheel of the axle.

Each of the damping systems 10a, 10b comprises a damper 11 which is couplable to a wheel suspension system (not shown) for the respective wheel (not shown). Each damper 11 is formed by a double-acting hydraulic cylinder 12 and a piston 13, wherein the piston 13 is movable back and forth in the hydraulic cylinder 12 (up and down in FIG. 1). The hydraulic cylinder 12 designed as a double-acting hydraulic cylinder of each of the damping systems 10a, 10b comprises a hydraulic chamber 14, 15 on each side of the piston 13.

Dependent upon which of the two hydraulic chambers 14, 15 is being supplied with hydraulic oil and from which of the two hydraulic chambers 15, 14 hydraulic oil is being discharged, the piston 13 can be displaced in either a first actuation direction or in an opposing second actuation direction. The first actuation direction of the piston 13 involves an actuation in the pulling direction and the second actuation direction of the piston 13 is an actuation in the pushing direction.

Each damping system 10a, 10b further comprises a hydraulic pump 16 that is drivable by a respective electric motor 17. The hydraulic pump 16 and the electric motor 17 of each damping system 10a, 10b form a respective motor-pump group 18. The hydraulic pump 16 is a reversible pump that can be driven by the respective electric motor 17 in different directions of rotation in order to provide different conveying directions.

Each damping system 10a, 10b of FIG. 1 further comprises a hydraulic unit 19 having a hydraulic reservoir 20 as well as valves 21, 22, 23, 24. The valves 21, 22 are check valves, and the valves 23, 24 are damping valves. The hydraulic reservoir 20 of each of the damping systems 10a, 10b engages in each case between the check valves 21, 22 and between the damping valves 23, 24 on hydraulic lines of the hydraulic unit 19 which are coupled to the hydraulic chambers 14, 15.

Dependent upon the conveying direction of the hydraulic pump 16 and preferably also dependent upon the position of the valves 21, 22, 23, 24 of each damping system, in order to displace the piston 13 in the first movement direction, that is the pulling direction, oil is supplied to the hydraulic chamber 14 and oil is removed from the hydraulic chamber 15, or, in order to provide a second movement direction of the piston 13 in the second movement direction, that is the pushing direction, oil is supplied to the hydraulic chamber 15 and oil is removed from the hydraulic chamber 14.

The hydraulic pump 16 of the motor-pump group 18 of the respective damping system 10a, 10b is connected to the hydraulic unit 19, comprising the hydraulic reservoir 20 and the valves 21, 22, 23, 24, of the respective damping system 10a, 10b which unit is preferably installed as a unit on the damper 12 and/or on the hydraulic cylinder 13, via hydraulic lines 25, 26.

A common control device 27 cooperates with the motor-pump groups 18 of the two damping systems 10a, 10b of the damping arrangement 10 of the axle of the active chassis. The electric motors 17 of the two motor-pump groups 18 are drivable by the common control device 27.

The two motor-pump groups 18 of the two damping systems 10a, 10b and the common control device 27 form a motor-pump unit 28 of the damping arrangement 10. The present invention relates to such details of the damping arrangement 10, with which it can be ensured that the motor-pump unit 28 of the damping arrangement 10 of the axle of the active chassis of the motor vehicle vibrates less strongly when the motor vehicle travels, without affecting noise development and thus without impairing the acoustics.

The motor-pump unit 28 of the damping arrangement 10 of the axle of an active chassis of a motor vehicle is attached to a subframe 30 or auxiliary frame of the axle via a carrier 29, in the preferred example embodiment shown to connection regions 31 of the subframe 30 for a stabilizer.

Instead of a stabilizer, the carrier 29 extends in the design space for the stabilizer, whereby the carrier 29 engages the connection areas 31 of the subframe 30 for a stabilizer instead of the stabilizer or is attached to these connection areas 31. The carrier 29 may also be referred to as a stabilizer replacement rod.

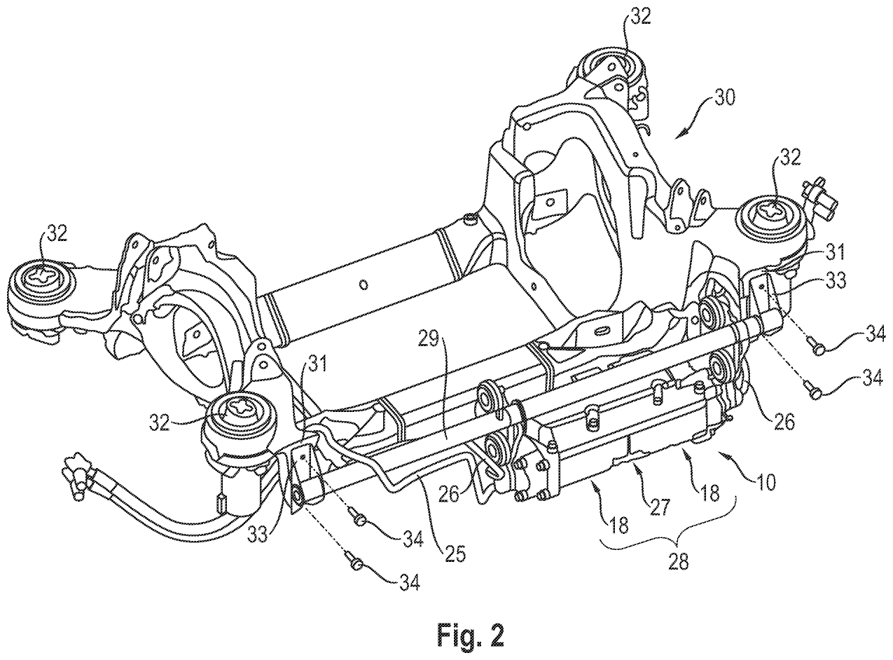

FIG. 2 shows a first variant of a damping arrangement 10 according to aspects of the invention together with a subframe 30. Bearings 32 are shown on the subframe 30, which serve to connect the subframe 30 to a body of the vehicle (not shown). Furthermore, the connection areas 31 of the subframe 30 for a stabilizer are shown.

In the preferred example embodiment, the carrier 29 of the motor-pump unit 28 of the damping arrangement 10 engages on the connection areas 31 of the subframe 30 for a stabilizer instead of a stabilizer on the axle comprising the subframe 30. A longitudinal axle of the carrier 29 preferably extends along a design space that would actually be provided for the stabilizer.

FIG. 2 shows that the carrier 29 is attached at its opposite ends via flanges 33 to the connection areas 31 of the subframe 30 for the stabilizer via fastening screws 34, wherein the connection areas 31 of the stabilizer 30 are also formed from flanges against which the flanges 33 come into contact.

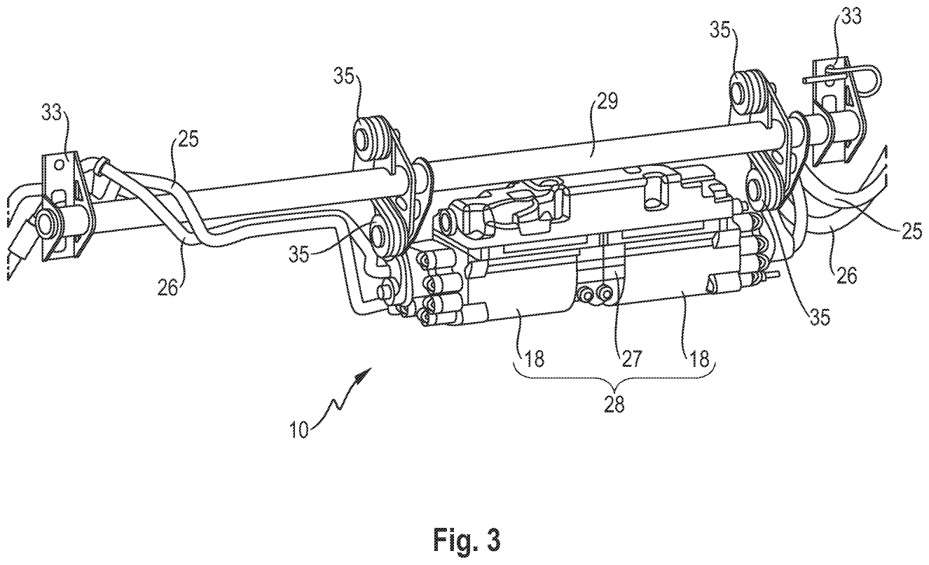

FIG. 3 shows the carrier 29 of the motor-pump unit 28 together with the motor-pump unit 28 in a stand-alone view without a subframe 30.

In the example embodiment of FIGS. 2 and 3, the motor-pump unit 28 is arranged below the carrier 29. The carrier 29 is rigidly attached to the subframe 30 via the flange 33, wherein in FIG. 3 the motor-pump unit 28 is attached to the carrier 29 via the bearing 35.

The bearings 35 have a defined bearing stiffness in the radial direction of the respective bearing 35, and thus in the longitudinal direction and in the vertical direction of the motor vehicle. This bearing stiffness of the bearings 35 in the radial direction is in particular between 450 N/mm and 850 N/mm, preferably between 500 N/mm and 800 N/mm, more preferably between 550 N/mm and 750 N/mm or between 600 N/mm and 700 N/mm.

This radial bearing stiffness is an average radial bearing stiffness of the respective bearing 35. This average radial bearing stiffness is preferably measured in a range between 0.2 mm and 0.7 mm of a radially deformed bearing 35 in the direction of deformation of the bearing 35.

The axial bearing stiffness, i.e., the bearing stiffness in the transverse direction of the motor vehicle, is of minor importance for the present invention.

The axial bearing stiffness of the respective bearing 35 is smaller than or less than the radial bearing stiffness, in particular 15% to 30% smaller or less than the radial bearing stiffness.

The bearings 35 are formed from an NR rubber or NBR rubber. Preferably, the rubber used has a hardness of 60±5 Shore A.

In FIGS. 2 and 3, although the motor-pump unit 28 of the damping arrangement 10 of the axle of an active chassis elastically engages on the carrier 29 via the bearings 35 and the carrier 29 engages rigidly on the subframe 30, it is alternatively possible that the motor-pump unit 28 is also rigidly attached to the carrier 29. Alternatively, corresponding rubber elastic bearings could also be provided in the area between the flanges 33 and the connection areas 31 of the subframe 30.

As shown in FIGS. 2 and 3, if the motor-pump unit 28 of the damping arrangement 10 of the axle of an active chassis is arranged below the carrier 29, however, the design shown in FIGS. 2 and 3, in which the motor-pump unit 28 is elastically attached to the carrier 29 via the bearings 35 and the carrier 29 is rigidly attached to the subframe 30, is preferred.

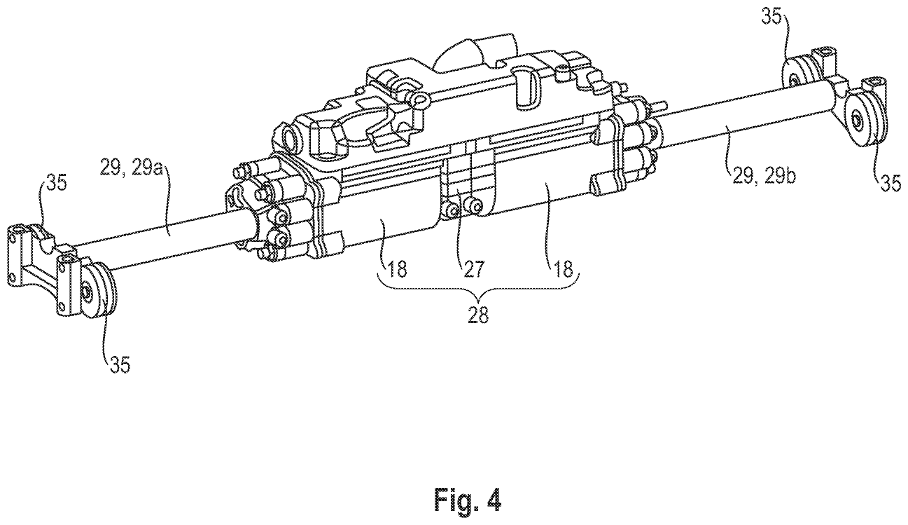

FIG. 4 shows an alternative to FIG. 3, in which the motor-pump unit 28 of the damping arrangement 10 of the axle of an active chassis is integrated into the carrier 29, such that the motor-pump unit 28 interrupts the carrier 29 or divides into sections 29a, 29b, such that one of the sections 29a and 29b of the carrier 29 extends on either side of the motor-pump unit 28.

In FIG. 4, the motor-pump unit 28 of the damping arrangement 10 of the axle of an active chassis is preferably rigidly attached to the respective section 29a, 29b of the carrier 29. The carrier 29, namely its sections 29a and 29b, are preferably attached to the subframe 30 via bearings 35, wherein these bearings in turn have a defined bearing stiffness in the radial direction of the bearing 35, and thus in the longitudinal direction and vertical direction of the motor vehicle.

The defined bearing stiffnesses have already been mentioned above for the example embodiment of FIGS. 2, 3 and also apply to the example embodiment of FIG. 4.

Although the embodiment shown in FIG. 4 is preferred in the case in which the motor-pump unit 28 is integrated into the carrier 29, it is also possible to elastically mount the motor-pump unit 28 on the respective sections 29a and 29b in FIG. 4 via corresponding bearings and then rigidly attach the sections 29a and 29b to the subframe 30. Also, both the motor-pump unit 28 could be rigidly attached to the sections 29a, 29b of the carrier 29, and the sections 29a, 29b of the carrier 29 could be rigidly attached to the subframe 30.

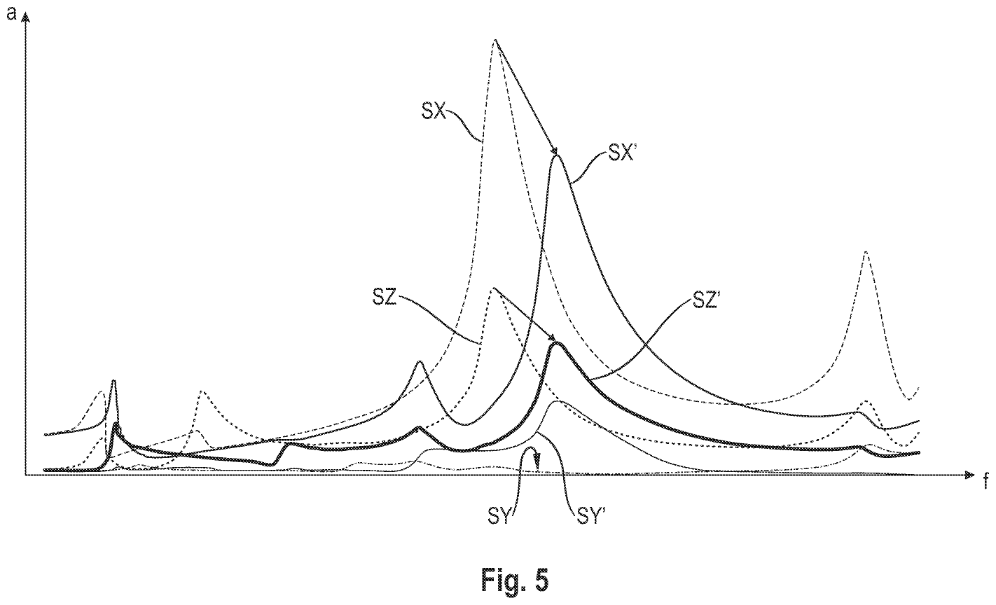

FIG. 5 illustrates the effect of the invention with the curve progressions SX, SY, SZ as well as SX′, SY′ and SZ′. The dashed curve progressions SX, SY and SZ show vibrations of the motor-pump unit 28 according to the prior art.

The curve progressions SX′, SY′ and SZ′ show vibrations of the motor-pump unit 28 which are formed using the invention, wherein SX and SX′ each visualize vibrations in the longitudinal direction, SZ and SZ′ vibrations in the vertical direction and SY and SY′ vibrations in the transverse direction of the vehicle. In FIG. 5, the accelerations a are plotted for the vibrations over the frequency f. FIG. 5 shows that the invention can significantly reduce the accelerations for the critical vibrations in the longitudinal direction X and the vertical direction Z of the vehicle. The maxima of accelerations shift to higher frequencies f.

What is claimed is:

1. A damping arrangement for an active chassis for an axle of a motor vehicle, wherein a respective damping system cooperates with each wheel of the axle, wherein each damping system comprises:
a damper having a double-acting hydraulic cylinder and a piston, wherein the damper is configured to be coupled to a wheel suspension system of the respective wheel,
a hydraulic pump and an electric motor for driving the respective hydraulic pump, wherein the hydraulic pump is configured to be driven by the electric motor in different directions of rotation to provide different conveying directions, and
a hydraulic unit having a hydraulic reservoir and valves,
wherein the hydraulic pump and the hydraulic unit of the respective damping system cooperate with hydraulic chambers of the hydraulic cylinder of the respective damping system in such a way that movement of the piston in either a first actuating direction or in a second actuating direction is dependent upon the conveying direction of the hydraulic pump of the hydraulic unit, wherein the hydraulic pumps and the electric motors of the damping systems are combined to form a motor-pump unit, wherein the motor-pump unit is attached via a carrier to either a subframe or to an auxiliary frame of the axle.

2. The damping arrangement of claim 1, wherein the carrier is attached to attachment areas of the subframe or auxiliary frame for a stabilizer.

3. The damping arrangement according to claim 2, wherein the carrier extends in a design space for the stabilizer instead of the stabilizer.

4. The damping arrangement according to claim 1, wherein the motor pump unit is arranged below the carrier.

5. The damping arrangement according to claim 4, wherein the motor-pump unit is rigidly attached to the carrier.

6. The damping arrangement according to claim 4, wherein the motor-pump unit is attached to the carrier via bearings, which have a bearing stiffness between 450 N/mm and 850 N/mm in a radial direction of the bearing and thus in a longitudinal direction and vertical direction of the motor vehicle.

7. The damping arrangement according to claim 4, wherein the carrier is rigidly attached to the subframe or the auxiliary frame.

8. The damping arrangement according to claim 1, wherein the motor-pump unit is integrated into the carrier, such that the motor-pump unit divides the carrier into two portions, and that one of the portions of the carrier extends on each side of the motor-pump unit.

9. The damping arrangement according to claim 8, wherein the motor-pump unit is rigidly attached to the carrier.

10. The damping arrangement according to claim 8, wherein the carrier is rigidly attached to the subframe or the auxiliary frame.

11. The damping arrangement according to claim 8, wherein the carrier is attached to the subframe or the auxiliary frame via bearings, which have a bearing stiffness between 450 N/mm and 850 N/mm in a radial direction of the bearing and thus in a longitudinal direction and vertical direction of the motor vehicle.

12. A motor vehicle having multiple axles, wherein a damping arrangement according to claim 1 is associated with each axle.
